(19) United States
(12) Patent Application Publication
(10) Pub. No.: US 2010/0048075 A1
(43) Pub. Date: Feb. 25, 2010

(54) METHOD OF MANUFACTURING A COMPOSITE FABRIC WITH WARM AND WATERPROOFING FEATURES

(75) Inventor: Sen-Mei Cheng, Chang Hwa Hsien (TW)

Correspondence Address: PAI PATENT & TRADEMARK LAW FIRM, 1001 FOURTH AVENUE, SUITE 3200, SEATTLE, WA, 98154, US

(73) Assignee: TAIWAN PAIHO LIMITED, Chang Hwa Hsien (TW)

(21) Appl. No.: 12/425,334

(22) Filed: Apr. 16, 2009

(30) Foreign Application Priority Data
Aug. 19, 2008 (TW) 97131619

(51) Int. Cl. B32B 27/12; B05D 3/02; B32B 5/02

(52) U.S. Cl. 442/89; 427/389.9

(57) ABSTRACT

A method for manufacturing a composite fabric that is warm and waterproof is disclosed. The method comprises the steps of crushing the material of carbon, heating the crushed material to a temperature in a range between 800° C. and 1000° C., rotating and churning the material to balance heating, mixing and coating the material on the surface of a textile layer. The composite fabric includes a textile layer and a carbon material layer. The carbon material layer includes carbon powder and thermoplastic PU (Polyurethane), a cross-linking agent, and a catalyst. The composite fabric is warm, waterproof, absorbs body odor and is anti-electrostatic.

### RELATED APPLICATIONS

This application claims priority to Taiwan Application Serial Number 97131619, filed Aug. 19, 2008, which is herein incorporated by reference.

### BACKGROUND

1. Field of Invention

The present invention relates to a fabric and a method of manufacturing thereof. More particularly, the present invention relates to a method of a composite fabric with warm and waterproofing features and a structure thereof. Moreover, the composite fabric is anti-electrostatic and can absorb undesirable body odor

2. Description of Related Art

There are various kinds of cloth. The more popular cloth is a new fabric with warm and waterproofing features. As shown in FIG. 1, a fabric of the prior art comprises a basic layer 001, a waterproofing layer 002 and a water-absorbing layer 003. The waterproofing layer 002 is made of a waterproofing material, and is formed on the interior surface of the basic layer 001 to prevent water from permeating, but can be permeated by water vapor. The water-absorbing layer 003 is primarily made of a bonding material, and is formed on the interior surface of the waterproofing layer 002. The material of the water-absorbing layer 003 is highly hydrophilic and hygroscopic.

The fabric of the prior art described above has the effect of waterproofing and allows body odor vapors to permeate out of the fabric, but there may be a lot of improvement in actual application.

First, the fabric of the prior art is waterproof but cannot prevent the electrostatic phenomenon. In a dry climate, static electricity aggregates easily, which is produced by rubbing the body of the user, and the static electricity usually shocks the user unpredictably, and may even hurt the user.

Second, the fabric for outside use, such as common hunting dress, the field mask (for ecological observation) and the fabric for outdoor shoes, needs to absorb the body odor. If the fabric for outside use can't prevent the human body odor from diffusing, wild animals may smell the human body odor more easily and placing the human in danger.

The inventor focused on the foregoing problem of the fabric of the prior art and continued to develop and improve the fabric. A method of manufacturing a composite fabric with warm and waterproofing features and a structure thereof are disclosed finally. The composite fabric is warm, waterproof, absorbs the body odor, and is anti-electrostatic.

### SUMMARY

Therefore, the purpose of this invention is to provide a method of manufacturing a composite fabric with warm and waterproofing features. The composite fabric made by the method is warm, waterproof, absorbs body odor, and is anti-electrostatic.

Another purpose of this invention is to provide a structure of a composite fabric with warm and waterproofing features. The composite fabric is warm, waterproof, absorbs body odor, and is anti-electrostatic.

According to the foregoing purpose, a method of manufacturing a composite fabric with warm and waterproofing features is disclosed. According to a preferred embodiment of the present invention, a method of manufacturing a warm, waterproof composite fabric comprises the acts of crushing a carbon material, heating the crushed carbon material to the temperature of a range between 800° C. and 1000° C., rotating and churning the crushed carbon material to balance heating, mixing and coating the mixed material on a surface of a textile layer. The foregoing steps have the characteristics described below, respectively.

The act of crushing a carbon material is to crush a bamboo charcoal material.

The act of heating the crushed carbon material to the temperature of a range between 800° C. and 1000° C. is to burn the crushed bamboo charcoal material without oxygen in a high temperature furnace, and keep the temperature of the high temperature furnace at a range between 800° C. and 1000° C.

The act of rotating and churning the crushed carbon material to balance heating is to rotate and churn the crushed bamboo charcoal material while it is burned without oxygen in the high temperature furnace described above, whereby the crushed bamboo charcoal material is balanced heating.

The act of mixing is to mix the crushed bamboo charcoal material with thermoplastic polyurethane (PU), a cross-linking agent and a catalyst to form a carbon material layer.

The act of coating the mixed material on a surface of a textile layer is to coat the carbon material layer formed by the foregoing mixed material on a surface of a textile layer.

According to the purpose of the present invention, a structure of a composite fabric with warm and waterproofing features is disclosed.

According to a preferred embodiment of the present invention, the structure comprises a textile layer and a carbon material layer. The textile layer is made of knitted fiber. The carbon material layer is bonded and cured on the surface of the textile layer, and the carbon material layer comprises a solute comprising a carbon powder, a cross-linking agent and a catalyst, and a solution comprising thermoplastic PU.

The advantages of the present invention are described below. The carbon material layer cured on the surface of the textile layer comprises 18% carbon powder (such as bamboo charcoal). Because the crushed carbon material is rotated and churned to balance heating at a temperature in a range between 800° C. and 1000° C., the carbon powder is electric conductive and then is anti-electrostatic.

Additionally, because the carbon powder can absorb the body odor in coordination with the thermoplastic PU and the thermoplastic PU is warm and waterproofing, the present invention is very adaptable for application in a hunting dress, the field mask (for ecological observation) and the fabric for outdoor shoes.

### BRIEF DESCRIPTION OF THE DRAWINGS

The invention can be more fully understood by reading the following detailed description of the embodiment, with reference made to the accompanying drawings as follows:

FIG. 1 is a sectional view of a fabric with warm and waterproofing features of the prior art;

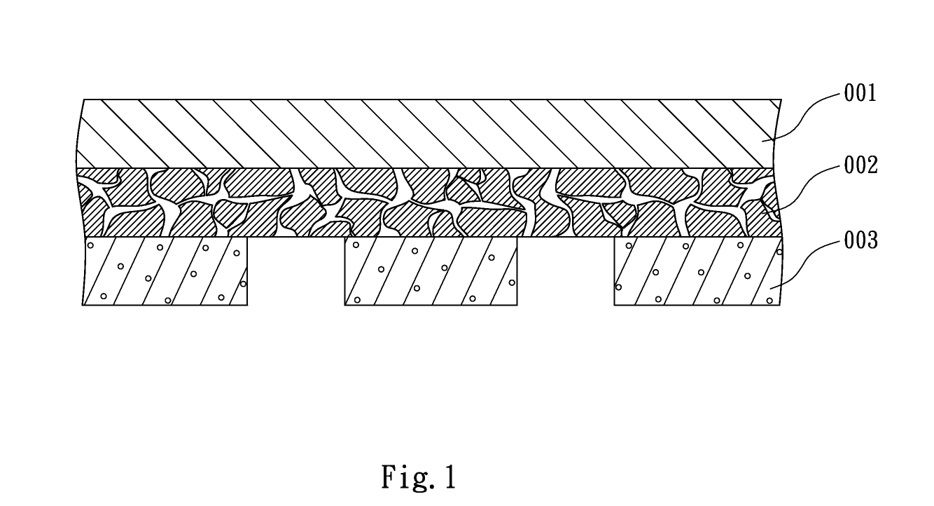

FIG. 2 is a flow chart of a method of manufacturing the preferred embodiment according to the present invention; and

FIG. 3 is a sectional view of a structure of the preferred embodiment according to the present invention.

### DETAILED DESCRIPTION

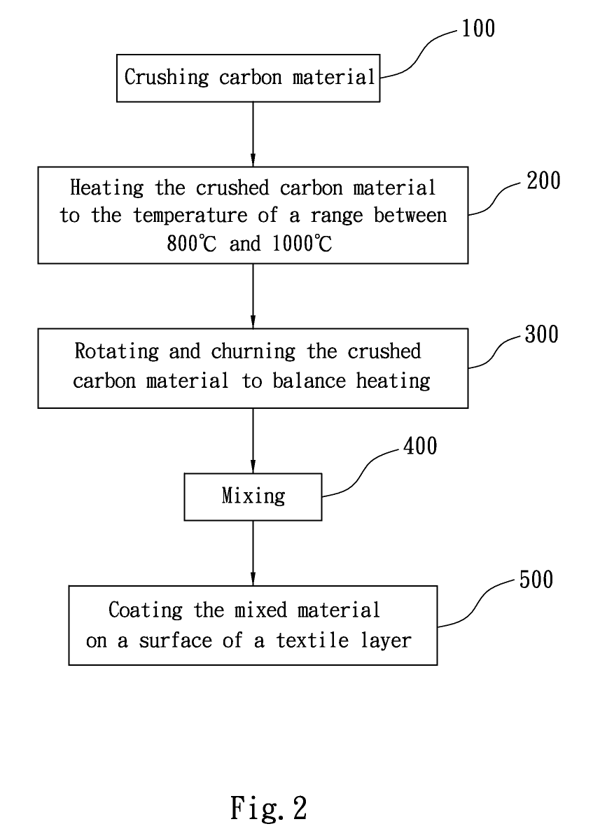

Refer to FIG. 2, a flow chart of a method of manufacturing a preferred embodiment according to the present invention is shown. The method comprises the following steps.

In the act of crushing a carbon material 100, a bamboo charcoal material is crushed to plate-shape or block-shape.

In the act of heating the crushed carbon material to the temperature in a range between 800° C. and 1000° C. 200, the crushed bamboo charcoal material described above is burned without oxygen in a high temperature furnace, and the temperature of the high temperature furnace is kept in the temperature range between 800° C. and 1000° C.

In the act of rotating and churning the crushed carbon material to balance heating 300, the crushed bamboo charcoal material is rotated and churned in a hollow container in the high temperature furnace while the crushed bamboo charcoal material is burned without oxygen in the high temperature furnace, which is described above. Rotating makes balance heating and then the crushed bamboo charcoal material is electric conductive.

In the act of mixing 400, the bamboo charcoal material is crushed in a size between 10⁻³ m and 10⁻⁶ m, and the preferred size of crushed bamboo charcoal powder is 10⁻⁴ m. And then the bamboo charcoal powder is mixed with thermoplastic PU, a cross-linking agent and a catalyst.

In the act of coating the crushed carbon material on a surface of a textile layer, the mixed material described above is coated on a surface of a textile layer to form a carbon material layer by fixing the thermoplastic PU that has fine holes, and the nano-carbon powder is dispersed in the carbon material layer evenly.

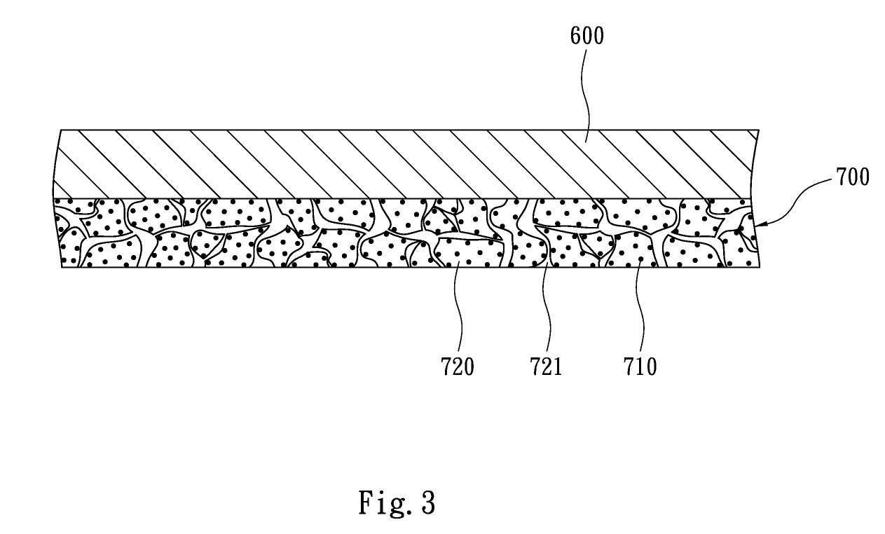

Referring to FIG. 3, a structure of a composite fabric made by the foregoing method is shown. According to the preferred embodiment of the present invention, the structure of a composite fabric with warm and waterproofing features is described below.

A textile layer 600 is made of knitted fiber.

A carbon material layer 700 is fixed on a surface of the textile layer 600 by curing the thermoplastic PU 720 comprising bamboo charcoal powder 710. The carbon material layer 700 comprises a solute comprising 18% bamboo charcoal powder 710, 5% cross-linking agent (not shown in FIG. 3) and 0.15% catalyst (not shown in FIG. 3), and a solution comprising diluted thermoplastic PU 720. The foregoing diluted thermoplastic PU 720 comprises 30% toluene (TOL) and 30% methyl ethyl ketone (MEK). Furthermore, fine holes 721 are formed after the thermoplastic PU 720 is cured.

According to the preferred embodiment of the present invention above, the advantages of the present invention is described below.

First, the carbon material layer fixed on a surface of a textile layer comprises 18% carbon powder (such as bamboo charcoal powder) and the carbon powder is rotated and churned to balance heating at a temperature in a range between 800° C. and 1000° C., so the carbon powder is electric conductive and then is anti-electrostatic.

Second, the nano-carbon powder can absorb body odor in coordination with the thermoplastic PU and the thermoplastic PU is warm and waterproof, so the present invention may be adaptable for application in hunting clothes, the field mask (for ecological observation) and the fabric for outdoor shoes.

Third, the fine holes are formed after the thermoplastic PU is cured, and the foregoing fine holes could not be passed by rainwater, but could be passed by one's sweat, so the carbon material layer formed by curing the thermoplastic PU comprising fine holes in the present invention is proof against rainwater, but is humidity permeable.

Although the present invention has been described in considerable detail with reference t certain embodiments thereof, other embodiments are possible. Therefore, their spirit and scope of the appended claims should no be limited to the description of the embodiments container herein.

What is claimed is:

1. A method of manufacturing a composite fabric that is warm and waterproof, the method comprising the acts of:
crushing a carbon material;
heating the crushed carbon material to a temperature in a range between 800° C. and 1000° C., wherein the crushed carbon material is burned without oxygen in a high temperature furnace, and the temperature of the high temperature furnace is kept in a range between 800° C. and 1000° C.;
rotating and churning the crushed carbon material to balance heating, wherein the crushed carbon material is rotated and churned while it is at high temperature;
mixing, wherein the crushed carbon material is mixed with diluted thermoplastic polyurethane (PU), a cross-linking agent and a catalyst; and
coating the mixed material on a surface of a textile layer, wherein the mixed material described above is coated on a surface of a textile layer, and the thermoplastic PU comprising fine holes is cured to form a carbon material layer.

2. The method of claim 1, wherein the carbon material is crushed to a size between 10⁻³ m and 10⁻⁶ m in the act of mixing, and the crushed carbon powder is dispersed in the carbon material layer evenly.

3. The method of claim 2, wherein the carbon material is crushed to a size of 10⁻⁴ m in the act of mixing.

4. The method of claim 1, wherein the act of rotating and churning the crushed carbon material to balance heating is in a high temperature furnace; and the crushed carbon material is rotated and churned in a hollow container in the high temperature furnace to balance heating, while the crushed carbon material is burned without oxygen in the high temperature furnace.

5. The method of claim 1, wherein the carbon material layer formed in the act of mixing comprises 18% carbon powder, 5% cross-linking agent and 0.15% catalyst.

6. The method of claim 1, wherein the diluted thermoplastic PU in the act of mixing comprises 30% toluene (TOL) and 30% methyl ethyl ketone (MEK).

7. The method of claim 2, wherein the crushed carbon material is a crushed bamboo charcoal powder with a size between 10⁻³ m and 10⁻⁶ m.

8. A structure of a composite fabric with warm and waterproofing features, the structure comprising:
a textile layer made of knitted fiber; and
a carbon material layer fixed on a surface of the textile layer, wherein the carbon material layer is made by curing the thermoplastic PU comprising carbon powder, and fine holes are formed by curing the thermoplastic PU.

9. The structure of claim 8, wherein the carbon powder is a bamboo charcoal powder, which is burned at a temperature in a range between 800° C. and 1000° C.
